(19) United States
(12) Patent Application Publication
(10) Pub. No.: US 2026/0081499 A1
(43) Pub. Date: Mar. 19, 2026

(54) ELECTRIC MOTOR HOUSING AND ELECTRIC MOTOR INCLUDING SAME

(71) Applicant: HYUNDAI MOBIS CO., LTD., Seoul (KR)

(72) Inventors: Seong Jun WOO, Yongin-si (KR); Yun Yeong PARK, Yongin-si (KR)

(73) Assignee: HYUNDAI MOBIS CO., LTD., Seoul (KR)

(21) Appl. No.: 18/884,866

(22) Filed: Sep. 13, 2024

(51) Int. Cl. H02K 5/10; F16B 5/02

(52) U.S. Cl. CPC H02K 5/10; F16B 5/02

(57) ABSTRACT

An electric motor housing includes a canister configured with a bottom and a side wall that bends around an outer periphery of the bottom and extends upward, thereby having an internal space and an open top, a cover configured with a cover plate that closes the top of the canister and is supported on the side wall, and an inner protrusion that protrudes from the cover plate toward the bottom, a fastener fastened to the inner protrusion by passing through the side wall in the thickness direction, and an O-ring interposed between an inner surface of the side wall and an outer surface of the inner protrusion.

### BACKGROUND

### Field

Exemplary embodiments of the present disclosure relate to an electric motor applied to a mechanical device or apparatus, and more particularly, to an electric motor housing and an electric motor including the same.

### Discussion Of The Related Art

For example, electric motors are widely used as power supply means in mechanical devices such as vehicles and various other machines and apparatuses. An electric motor housing includes a canister having an internal space in which a stator and a rotor are housed, and a cover engaged with the canister to close the internal space of the canister.

Furthermore, to prevent moisture from entering inside the housing, a moisture seal structure may be used at the junction where the canister and cover meet. However, when the moisture seal structure is used, the outer diameter of the junction where the canister and cover meet expands radially, which may require a large space for installing the electric motor. Therefore, it is difficult to compactly design a mechanical device or apparatus including the electric motor, and it is also difficult to commonly use and apply the electric motor.

### SUMMARY

Exemplary embodiments of the present disclosure are directed to providing an electric motor housing that minimizes expansion of its outer diameter while maintaining moisture seal performance, and an electric motor the same.

In an embodiment, an electric motor housing is provided, including: a canister configured with a bottom and a side wall that bends around an outer periphery of the bottom and extends away from the bottom, thereby having an internal space and a top that is open; a cover configured with a cover plate that closes the top of the canister and is supported on the side wall, and an inner protrusion that protrudes from the cover plate toward the bottom; a fastener fastened to the inner protrusion by passing through the side wall in the thickness direction; and an O-ring interposed between an inner surface of the side wall and an outer surface of the inner protrusion.

The O-ring may be positioned lower than the fastener.

The fastener may be a fastening screw that includes a body having an external thread pattern on its outer peripheral surface and a head expanded from an end of the body, having a greater diameter than the body. The side wall may have a screw insertion hole through which the fastening screw is passed. The inner protrusion may have a screw hole into which the body is securely fitted.

The screw hole may be blocked off so as not to pass through an inner surface of the inner protrusion.

The screw insertion hole includes a head insertion portion recessed inward from an outer surface of the side wall for inserting the head of the fastener and a body insertion portion having a smaller inner diameter than the head insertion portion, which allows the body of the fastener to pass therethrough but not the head.

A distance from a center of the canister to an outer surface of the screw insertion hole may be greater than or equal to a minimum distance from the center of the canister to an outer surface of the side wall.

The difference between the distance from the center of the canister to the outer surface of the screw insertion hole and the minimum distance from the center of the canister to the outer surface of the side wall may be less than or equal to 10 mm.

In another embodiment, an electric motor is provided, including: an electric motor housing that includes a canister configured with a bottom and a side wall that bends around an outer periphery of the bottom and extends away from the bottom, thereby having an internal space and a top that is open, a cover configured with a cover plate that closes the top of the canister and is supported on the side wall, and an inner protrusion that protrudes from the cover plate toward the bottom, a fastener fastened to the inner protrusion by passing through the side wall in the thickness direction, and an O-ring interposed between an inner surface of the side wall and an outer surface of the inner protrusion; a motor shaft extending from the electric motor housing, having one end positioned inside and another end positioned outside the electric motor housing; a rotor configured to be positioned inside the internal space of the canister and securely engaged with the motor shaft to rotate coaxially with the motor shaft; and a stator configured to be secured to an inner surface of the side wall and to create a magnetic field that rotates the rotor and the motor shaft by electrical energy.

The motor shaft may extend along a straight line to pass through the cover.

According to the embodiments, in the electric motor housing, the fastener is fastened to the inner protrusion of the cover by passing inwardly through the side wall of the canister, and the O-ring is interposed between the side wall of the canister and the inner protrusion of the cover. This minimizes the expansion of the outer diameter of the electric motor housing and improves the reliability of the moisture seal performance to prevent moisture from entering inside the electric motor housing.

According to the embodiments, the electric motor including the electric motor housing may be installed in a limited space. Therefore, it is easy to compactly design a mechanical device or apparatus including the electric motor, and it is also easy to commonly use and apply the electric motor to various mechanical devices or apparatuses.

### BRIEF DESCRIPTION OF THE DRAWINGS

FIG. 1 is a perspective view of an electric motor according to an embodiment of the present disclosure.

FIG. 2 is a cross-sectional view of an electric motor according to an embodiment of the present disclosure.

FIG. 3 is an exploded perspective view of an electric motor housing of FIG. 1.

FIG. 4 is a perspective view of an electric motor, which is a subject of comparison in the present disclosure.

### DETAILED DESCRIPTION

Embodiments of an electric motor hosing and an electric motor including the same according to the present disclosure will be described hereinafter in detail with reference to the accompanying drawings. The terminology used herein is intended to appropriately describe preferred embodiments of the present disclosure, and may vary depending on the intentions of the user or operator or the conventions of the field to which the present disclosure pertains. Therefore, the definition of the terminology should be made according to the overall disclosure set forth herein.

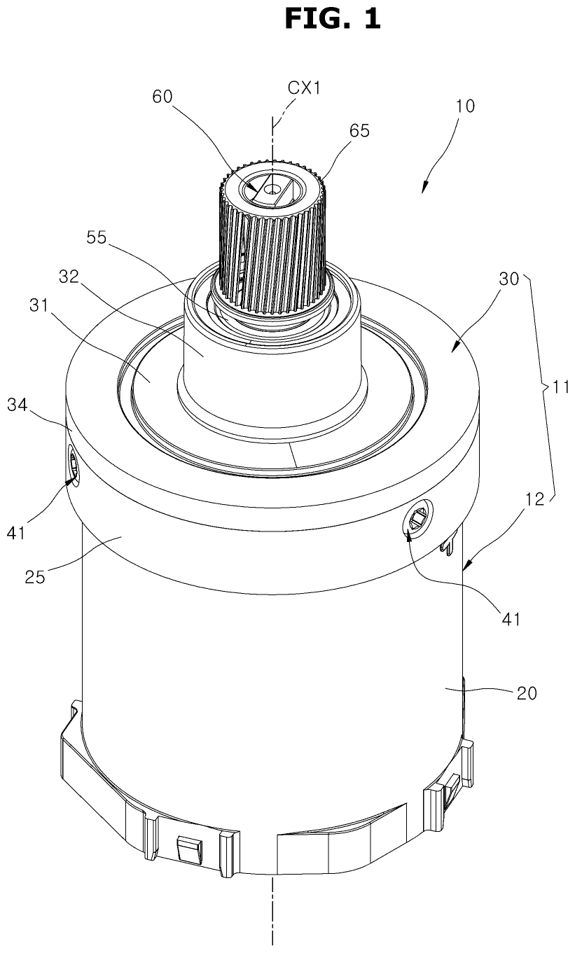

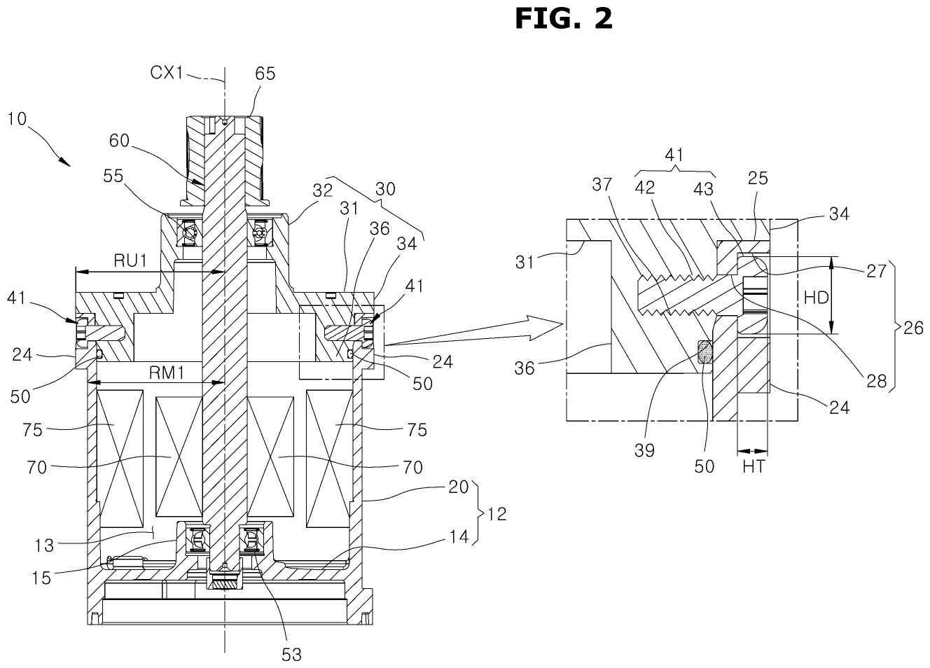

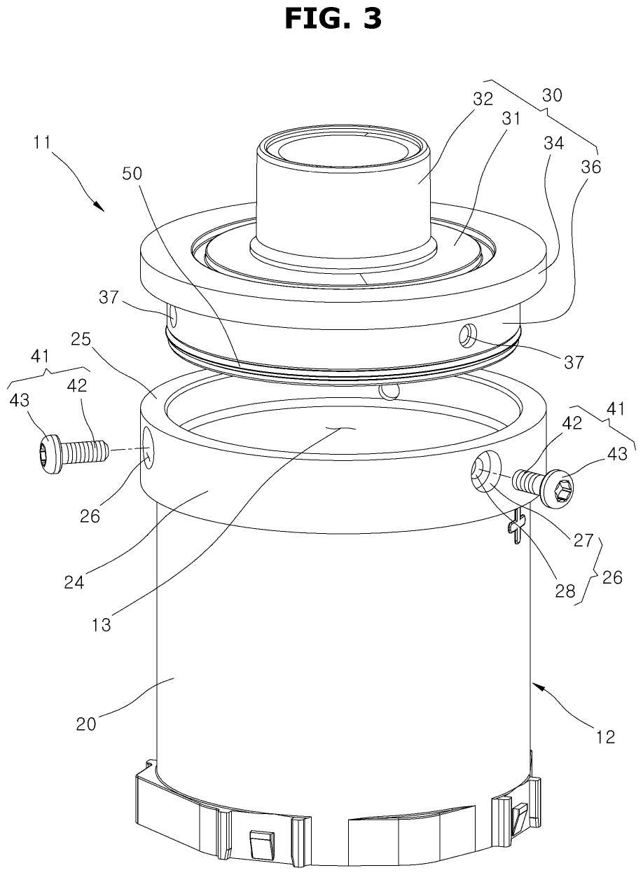

FIG. 1 is a perspective view of an electric motor according to an embodiment of the present disclosure. FIG. 2 is a cross-sectional view of an electric motor according to an embodiment of the present disclosure. FIG. 3 is an exploded perspective view of an electric motor housing of FIG. 1. Referring to FIGS. 1 to 3, an electric motor 10 according to an embodiment of the present disclosure includes an electric motor housing 11, a motor shaft 60, a rotor 70, and a stator 75. The electric motor 10 may be used, for example, in a motor driven power steering (MDPS) system of a vehicle.

The electric motor housing 11 may include a canister 12, a cover 30, a fastener 41, and an O-ring 50. The canister 12 may be a substantially cylinder-shaped member and include a bottom 14 and a side wall 20 that bends around an outer periphery of the bottom 14 and extends upward. The bottom 14 and the side wall 20 may create an internal space 13 inside the canister 12, where the rotor 70 and the stator 75 are housed. The top of the canister 12 may be open.

The bottom 14 may include a shaft supporter 15 at the center, which rotatably supports a lower portion of the motor shaft 60. In other words, the lower portion of the motor shaft 60 may be rotatably supported by the shaft supporter 15 via a first bearing 53. Specifically, the first bearing 53 may be inserted into the shaft supporter 15. The first bearing 53 may be interposed between an outer peripheral surface of the lower portion of the motor shaft 60 and an inner peripheral surface of the shaft supporter 15.

The motor shaft 60 extends along an axis CX1, which is a vertical straight line. The motor shaft 60 may rotate about the axis CX1. The side wall 20 is a tubular portion that extends vertically along the axis CX1. The axis CX1 may coincide with the center of the side wall 20. An upper portion 24 of the side wall 20 may extend radially outward in a stepped fashion compared to the portion below.

The cover 30 may include a cover plate 31, a shaft supporter 32, and an inner protrusion 36. The cover plate 31 is a substantially disk-shaped portion that closes the top of the open canister 12. When the cover 30 is supported on the canister 12, an outer peripheral edge 34 of the cover plate 31 may come into contact with and be supported by a stepped upper edge 25 of the upper portion 24.

The shaft supporter 32 is an annular portion that surrounds an upper portion of the motor shaft 60, which may rotatably support the upper portion of the motor shaft 60. In other words, the upper portion of the motor shaft 60 may be rotatably supported by the shaft supporter 32 via a second bearing 55. Specifically, the second bearing 55 may be inserted into the shaft supporter 32. The second bearing 55 may be interposed between an outer peripheral surface of the upper portion of the motor shaft 60 and an inner peripheral surface of the shaft supporter 32.

The inner protrusion 36 is a portion that protrudes in an annular shape from the cover plate 31 toward the bottom 14, in other words, downward. When the cover 30 is supported on the canister 12, the inner protrusion 36 is fitted inside the upper portion 24 of the side wall 20, and an outer surface of the inner protrusion 36 and an inner surface of the side wall 20 may face each other.

The fastener 41 may be fastened to the inner protrusion 36 by passing through the side wall 20 in the thickness direction. Specifically, the fastener 41 may be a fastening screw 41, which includes a body 42 having an external thread pattern on its outer peripheral surface, and a head 43 expanded from an end of the body 42, having a greater diameter HD than the body 42.

The fastening screw 41 may be fastened to the inner protrusion 36 by passing through the side wall 20, with the length direction of the body 42 aligned parallel to the radial direction centered on the axis CX1. The side wall 20 may have a screw insertion hole 26 through which the fastening screw 41 is passed.

The screw insertion hole 26 may include a head insertion portion 27 recessed inward from an outer surface of the side wall 20 for inserting the head 43, and a body insertion portion 28 having a smaller inner diameter than the head insertion portion 27, which allows the body 42 to pass therethrough but not the head 43.

The width of the head insertion portion 27 may be greater than the diameter HD of the head 43. The depth of the head insertion portion 27 may be greater than or equal to the height HT of the head 43, aligned parallel to the length direction of the body 42.

The inner protrusion 36 may have a screw hole 37 into which the body 42 is securely fitted. An internal thread pattern, engaged with the external thread pattern on the body 42, may be provided on an inner peripheral surface of the screw hole 37. The screw hole 37 may be blocked off so as not to pass through an inner surface of the inner protrusion 36.

The cover 30 is placed on top of the canister 12 such that the inner protrusion 36 is fitted inside the side wall 20, and the outer peripheral edge 34 of the cover plate 31 comes into contact with and is supported by the upper edge 25 of the side wall 20. The cover 30 is then rotated to an appropriate angle with respect to the canister 12 such that the screw insertion hole 26 and the screw hole 37 are aligned in a radially straight line. The fastening screw 41 is inserted into the screw insertion hole 26 and rotated to fasten the body 42 to the screw hole 37, thereby securely engaging the cover 30 with the canister 12.

The fastening screws 41 may be provided in plurality and be spaced apart at equal angles around the axis CX1. The number of screw insertion holes 26 and screw holes 37 may also be provided in plurality to correspond to the number of fastening screws 41.

An O-ring 50 is interposed between an inner surface of the side wall 20 and an outer surface of the inner protrusion 36. The O-ring 50 may be made of rubber and extend along an annular path. The O-ring 50 may prevent moisture from entering inside the electric motor housing 11 through the space between the cover 30 and the canister 12, specifically between the outer peripheral edge 34 of the cover plate 31 and the upper edge 25 of the side wall 20.

The outer surface of the inner protrusion 36 may have an annular O-ring groove 39 in which the O-ring 50 is mounted. However, unlike what is shown in FIG. 2, the inner surface of the side wall 20 may have an annular O-ring groove in which the O-ring 50 is mounted.

The O-ring 50 may be positioned lower than the fastener 41. In other words, parallel to the axis CX1, the distance from the upper edge of the side wall 20 to the O-ring 50 may be greater than the distance from the upper edge of the side wall 20 to the fastening screw 41.

In this case, the O-ring 50 may also prevent moisture, which enters through the screw insertion hole 26, from entering the rotor 70 and the stator 75 inside the electric motor housing 11. The moisture seal performance is maintained through the O-ring 50, thereby preventing corrosion, damage, and subsequent failures of the rotor 70 and the stator 75 housed inside the electric motor housing 11.

As described above, the screw hole 37 is blocked off so as not to pass through the inner surface of the inner protrusion 36. Therefore, moisture entering through the screw insertion hole 26 may not penetrate into the internal space 13 of the electric motor housing 11 by passing through the inner protrusion 36.

The motor shaft 60 may extend along the axis CX1 such that one end, specifically the lower portion, is positioned inside the electric motor housing 11, and the other end, specifically the upper portion, is positioned outside the electric motor housing 11. As described above, the motor shaft 60 passes through the cover 30 via the shaft supporter 32 of the cover 30. A motor shaft gear 65 may be securely engaged with an upper portion of the cover 30 to transmit power from the rotating motor shaft 60.

The rotor 70 is positioned inside the internal space 13 of the electric motor housing 11 and securely engaged with the motor shaft 60 to rotate coaxially with the motor shaft 60. The stator 75 may be secured to an inner surface of the side wall 20 and create a magnetic field that rotates the rotor 70 and the motor shaft 60 by electrical energy. In other words, when power is supplied to the stator 75 from outside the electric motor 10, the rotor 70 and the motor shaft 60 may rotate about the axis CX1.

The distance RU1 from the center of the canister 12 (i.e., the axis CX1) to the location of the screw insertion hole 26, specifically the outer surface of the upper portion 24, may be greater than or equal to a minimum distance RM1 from the center of the canister 12 (i.e., the axis CX1) to the outer surface of the side wall 20. The minimum distance RM1 from the center of the canister 12 (i.e., the axis CX1) to the outer surface of the side wall 20 may be the distance from the axis CX1 to the outer surface of the side wall 20 that is stepwise adjacent to the upper portion 24.

The difference between the distance RU1 from the center of the canister 12 (i.e., the axis CX1) to the outer surface of the upper portion 24 and the minimum distance RM1 from the center of the canister 12 (i.e., the axis CX1) to the outer surface of the side wall 20 may be less than or equal to 10 mm. This difference, denoted as ‘RU1−RM1,’ may be greater than the height HT of the head 43 of the fastening screw 41 and less than or equal to twice the height HT of the head 43.

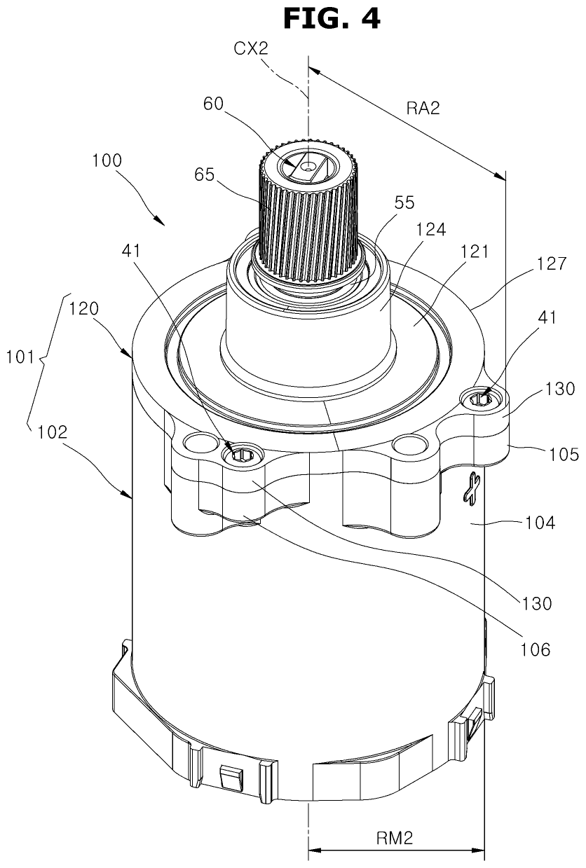

FIG. 4 is a perspective view of an electric motor, which is a subject of comparison in the present disclosure. Referring to FIG. 4, an electric motor 100, the subject of comparison, includes an electric motor housing 101, a motor shaft 60, a rotor (not shown), and a stator (not shown), similar to an electric motor 10 according to the embodiment of the present disclosure shown in FIGS. 1 to 3.

The motor shaft 60, rotor, and stator included in the electric motor 100, the subject of comparison, are identical to the motor shaft 60, rotor 70, and stator 75 included in the electric motor 10 according to the embodiment of the present disclosure. Therefore, redundant descriptions are omitted.

The electric motor housing 101 may include a canister 102, a cover 120, a fastening screw 41, and an O-ring (not shown). The canister 102 is a substantially cylinder-shaped member, which includes a bottom (not shown), a side wall 104 that bends around an outer periphery of the bottom and extends upward, and a screw engagement portion 105 that extends radially outward from an upper portion of an outer surface of the side wall 104.

The cover 120 may include a cover plate 121, a shaft supporter 124, and a screw insertion portion 130. The cover plate 121 is a substantially disk-shaped portion that closes the top of the open canister 102. The shaft supporter 124 is an annular portion that surrounds an upper portion of the motor shaft 60, which may rotatably support the upper portion of the motor shaft 60 via a bearing 55.

The screw insertion portion 130 extends radially outward from an outer peripheral edge 127 of the cover plate 121. The screw insertion portion 130 and the screw engagement portion 105 are aligned parallel to an axis CX2 of the motor shaft 60, both portions being vertically aligned and engaged. The fastening screw 41 passes through the screw insertion portion 130 parallel to the axis CX2 and is fastened to the screw engagement portion 105, thereby securely engaging the cover 120 with the canister 102.

The distance RU2 from the center of the canister 102 (i.e., the axis CX2) to the outer surface of the screw insertion portion 130 may be greater than a minimum distance RM2 from the center of the canister 102 (i.e., the axis CX2) to the outer surface of the side wall 104. The minimum distance RM2 from the center of the canister 102 (i.e., the axis CX2) to the outer surface of the side wall 104 may be the distance from the axis CX2 to the outer surface of the side wall 104 that is stepwise adjacent to the screw engagement portion 105.

The difference between the distance RU2 from the center of the canister 102 to the outer surface of the screw insertion portion 130 and the minimum distance RM2 from the center of the canister 102 (i.e., the axis CX2) to the outer surface of the side wall 104 is denoted as ‘RU2−RM2.’ This difference may be greater than the diameter HD of the head 43 (see FIG. 2) of the fastening screw 41. In general, the diameter HD of the head 43 is greater than or equal to twice the height HT of the head 43.

As described with reference to FIG. 2, in the electric motor housing 11 according to the embodiment of the present disclosure, the RU1−RM1 may be greater than the height HT of the head 43 and less than or equal to twice the height HT of the head 43. On the other hand, the RU2−RM2 of the electric motor housing 101 according to Comparative Example is greater than or equal to twice the height HT of the head 43.

Therefore, assuming that the electric motor 10 in FIG. 2 and the electric motor 100 in FIG. 4 have the same output and that the RM1 and RM2 are equal, the maximum outer diameter of the electric motor housing 11 according to the embodiment of the present disclosure is smaller than the maximum outer diameter of the electric motor housing 101 according to the Comparative Example. In other words, the electric motor housing 11 according to the embodiment of the present disclosure is advantageous for compact and miniaturized design of the electric motor.

In the electric motor housing 11 of the present disclosure as described above, the fastener 41 passes inwardly through the side wall 20 of the canister 12 and is engaged with the inner protrusion 36 of the cover 30, and the O-ring 50 is interposed between the side wall 20 of the canister 12 and the inner protrusion 36 of the cover 30. This minimizes the expansion of the outer diameter of the electric motor housing 11 and improves the reliability of the moisture seal performance to prevent moisture from entering inside the electric motor housing 11.

The electric motor 10 including the electric motor housing 11 may be installed in a limited space. Therefore, it is easy to compactly design a mechanical device or apparatus including the electric motor 10, and it is also easy to commonly use and apply the electric motor 10 to various mechanical devices or apparatuses.

Although embodiments of the present disclosure have been described with reference to the accompanying drawings, these embodiments are provided for the illustrative purpose. It will be apparent to those skilled in the art that various modifications and equivalent embodiments can be made from these embodiments disclosed herein. Accordingly, the true scope of the present disclosure should be defined only by the appended claims.

What is claimed is:

1. An electric motor housing comprising:
a canister configured with a bottom and a side wall that bends around an outer periphery of the bottom and extends away from the bottom, thereby having an internal space and a top that is open;
a cover configured with a cover plate that closes the top of the canister and is supported on the side wall, and an inner protrusion that protrudes from the cover plate toward the bottom;
a fastener fastened to the inner protrusion by passing through the side wall in a thickness direction; and
an O-ring interposed between an inner surface of the side wall and an outer surface of the inner protrusion.

2. The electric motor housing of claim 1, wherein the O-ring is positioned lower than the fastener.

3. The electric motor housing of claim 1, wherein
the fastener is a fastening screw that comprises a body having an external thread pattern on an outer peripheral surface of the body and a head expanded from an end of the body, having a greater diameter than the body,
the side wall has a screw insertion hole through which the fastening screw is passed, and
the inner protrusion has a screw hole into which the body is securely fitted.

4. The electric motor housing of claim 3, wherein the screw hole is blocked off so as not to pass through an inner surface of the inner protrusion.

5. The electric motor housing of claim 3, wherein the screw insertion hole comprises
a head insertion portion recessed inward from an outer surface of the side wall for inserting the head of the fastener, and
a body insertion portion having a smaller inner diameter than the head insertion portion, which allows the body of the fastener to pass therethrough but not the head.

6. The electric motor housing of claim 3, wherein a distance from a center of the canister to an outer surface of the screw insertion hole is greater than or equal to a minimum distance from the center of the canister to an outer surface of the side wall.

7. The electric motor housing of claim 6, wherein a difference between the distance from the center of the canister to the outer surface of the screw insertion hole and the minimum distance from the center of the canister to the outer surface of the side wall is less than or equal to 10 mm.

8. An electric motor comprising:
an electric motor housing that comprises a canister configured with a bottom and a side wall that bends around an outer periphery of the bottom and extends away from the bottom, thereby having an internal space and a top that is open, a cover configured with a cover plate that closes the top of the canister and is supported on the side wall, and an inner protrusion that protrudes from the cover plate toward the bottom, a fastener fastened to the inner protrusion by passing through the side wall in a thickness direction, and an O-ring interposed between an inner surface of the side wall and an outer surface of the inner protrusion;
a motor shaft extending from the electric motor housing, having one end positioned inside and another end positioned outside the electric motor housing;
a rotor configured to be positioned inside the internal space of the canister and securely engaged with the motor shaft to rotate coaxially with the motor shaft; and
a stator configured to be secured to an inner surface of the side wall and to create a magnetic field that rotates the rotor and the motor shaft by electrical energy.

9. The electric motor of claim 8, wherein the motor shaft extends along a straight line to pass through the cover.
